(19) United States
(12) Patent Application Publication
(10) Pub. No.: US 2007/0121433 A1
(43) Pub. Date: May 31, 2007

(54) OPTICAL INFORMATION RECORDING AND REPRODUCING APPARATUS

(75) Inventor: Chihiro NAGURA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/561,492

(22) Filed: Nov. 20, 2006

(30) Foreign Application Priority Data
Nov. 29, 2005 (JP) 2005-343879

(51) Int. Cl. G11B 7/00

(52) U.S. Cl. 369/44.11; 369/44.37

(57) ABSTRACT

Provided is an optical information recording and reproducing apparatus for recording and reproducing information using holography by irradiating a spatial modulator with a light beam from a first laser light source, separately generating information light and reference light sharing an optical axis, and condensing the generated light beam onto the information recording medium by an objective lens including a driving unit for moving the objective lens, in which the driving unit moves the objective lens in parallel to the light beam in accordance with the incident angle of light passing through the center of the spatially modulated light beam with respect to the information recording medium. The apparatus enables a stable recording and reproduction performance operation even in the case where a relative tilt occurs between an information recording medium and an optical pickup without enlarging an apparatus.

### BACKGROUND OF THE INVENTION

1. Field of the Invention

The present invention relates to an optical information recording and reproducing apparatus, and more particularly, to an optical information recording and reproducing apparatus for recording information with respect to a recording medium on which information is recorded using holography, and for reproducing information from the recording medium having information recorded thereon.

2. Description of the Related Art

FIG. 10 is a block diagram showing an optical system of a conventional coaxial type holographic memory (collinear type).

First, a description is given on a case where recording is performed with respect to a hologram disk 216 serving as a recording medium by using the above-mentioned optical system.

A light beam outputted from a green laser 210 of a light source is collimated by a collimator 202, and irradiates a spatial optical modulating element SLM 204 via a mirror 203.

In FIG. 10, a deformable mirror device (DMD) is used for the SLM 204.

Light reflected by a pixel representing the information “1” on the SLM 204 is reflected to the hologram disk 216, and light reflected by a pixel representing the information “0” is not reflected to the hologram disk 216.

On the collinear SLM 204, a portion for modulating information light 206 and a portion for modulating reference light 205 surrounding the portion for modulating the information light 206 in an annular shape are provided.

The reference light 205 and the information light 206 reflected by the pixel representing the information “1” on the SLM 204 are transmitted through a polarized beam splitter PBS 207 as P-polarized light. After that, the reference light 205 and the information light 206 are incident upon a hologram disk 216 via a relay lens (1) 208, a mirror 209, a relay lens (2) 210, and a dichroic BS 211.

The reference light 205 and the information light 206 transmitted through a quarter wavelength plate QWP 212 and converted to circularly polarized light (e.g., right-handed circularly polarized light) are reflected by a mirror 213 to be incident upon an objective lens 214 with a focal distance F.

A pattern displayed on the SLM 204 by two relay lenses (1) 208 and (2) 210 forms an intermediate image at a distance F before the objective lens 214.

Thus, a so-called 4F optical system is configured, in which a pattern image (not shown) on the SLM, the objective lens 214, and the hologram disk 216 are placed at the distance F from each other.

The hologram disk 216 has a disk shape and is held rotatably on a spindle motor 215.

The reference light 205 and the information light 206 are condensed onto a recording medium (not shown) on the disk by the objective lens 214 and interfere with each other to form an interference fringe.

On a polymer material in a recording medium, an interference fringe pattern during this recording is recorded as a refractive index distribution, and a digital volume hologram is formed. Further, in the recording medium, a reflective film is provided.

A red laser 220 for emitting laser light to a recording medium which is non-photosensitive thereto is provided, in addition to a green laser 201 for performing recording and reproduction with respect to a hologram, whereby a displacement of the hologram disk 216 can be detected with high precision, with the above-mentioned reflective film being a reference surface.

As a result, even when surface deviating and decentering occur in the hologram disk 216, a recording spot can be allowed to follow the recording medium surface dynamically using an optical servo technique, and an interference fringe pattern can be recorded with high precision.

The above-mentioned matter will be described briefly below.

A linearly polarized light beam outputted from the red laser 220 is transmitted through a beam splitter BS 221, and collimated by a lens 222. After that, the light beam is reflected by a mirror 223 and the dichroic BS 211, and travels to the hologram disk 216.

The light beam transmitted through the quarter wavelength plate QWP 212 and converted into circularly polarized light (e.g., right-handed circularly polarized light) is reflected by the mirror 213 to be incident upon the objective lens 214. After that, the light beam is condensed as a minute optical spot on a reflective surface of the hologram disk 216.

The reflected light beam becomes reverse circularly polarized light (e.g., left-handed circularly polarized light), and is incident upon the objective lens 214 again to be collimated. After that, the collimated light beam is reflected by the mirror 213, transmitted through the quarter wavelength plate QWP 212, and converted into a linearly polarized light beam perpendicular to a forward path.

The light beam reflected by the dichroic BS 211 passes through the mirror 223 and the lens 222 in the same way as in the forward path, and is reflected by the beam splitter BS 221 to be guided to a photodetector 224.

The photodetector 224 has a plurality of light-receiving surfaces (not shown) and can detect positional information on a reflective surface by a known method. Based on the detected positional information, the photodetector 224 can perform focusing and tracking of the objective lens 214.

Next, a case where recorded information is reproduced from the hologram disk 216 serving as a recording medium by using the above-mentioned optical system will be described.

The light beam outputted from the green laser 201 of a light source irradiates the spatial light modulating element SLM 204 in the same way as in recoding.

During reproduction, only a portion modulating the reference light 205 on the SLM 204 represents the information “1”, and a portion modulating the information light 206 displays information “0”.

Thus, only a part of the reference light reflected by a pixel is reflected to the hologram 216, and the information light is not reflected to the hologram 216.

In the same way as in recording, the reference light 205 becomes circularly polarized light (e.g., right-handed circularly polarized light) to be condensed onto a recording medium (not shown) on a disk, and reproduces information light from the recorded inference fringe.

The information light reflected by the reflective film in the recording medium becomes reverse circularly polarized light (e.g., left-handed circularly polarized light), and is incident upon the objective lens 214 again to be collimated. After that, the collimated light is reflected by the mirror 213, transmitted through the quarter wavelength plate QWP 212, and converted into a linearly polarized light beam (S-polarized light) perpendicular to the forward path.

At this time, an intermediate image of a display pattern of SLM reproduced at a distance F from the objective lens 214 is formed.

The light beam transmitted through the dichroic BS 211 is incident upon the polarized beam splitter PBS 207 via the relay lens (2) 210, the mirror 209, and the relay lens (1) 208.

The light beam reflected by the PBS 207 forms an image again as an intermediate image of a display pattern of SLM at a position conjugate to the spatial light modulating element SLM 204 by the relay lenses (2) and (1).

At this position, an opening 217 is previously placed, and unnecessary reference light in the periphery of the information light is blocked. Through the lens 218, the re-formed intermediate image forms an SLM display pattern only of a portion of the information light on a CMOS sensor 219.

Consequently, unnecessary reference light is not incident upon the CMOS sensor 219, so that a reproduced signal with a satisfactory S/N can be obtained.

The characteristics of a holographic memory are as follows. If the reference light during recording and the reference light during reproduction are not incident upon an information recording medium at the same angle, a diffraction efficiency is decreased remarkably, which makes it difficult to perform exact reading.

In view of this, as described in Japanese Patent Application Laid-Open No. 2001-273650, an optical pickup body is tilted in accordance with the relative tilt between the information recording medium and the optical pickup. Further, as described in Japanese Patent Application Laid-Open No. 2005-32309, a technique of shifting a spatially modulated light beam has been proposed.

However, in a case of correcting the relative tilt between the information recording medium and the optical pickup with the above-mentioned configuration, a driving mechanism is required in addition to a driving portion for performing tracking and focus servo, which may cause an increase in size and cost.

Further, in a case of correcting the relative tilt by shifting an entire modulation pattern, both the configurations of a spatial modulating element and an area sensor become complicated, which may also cause an increase in size and cost.

### SUMMARY OF THE INVENTION

It is an object of the present invention to provide an optical information recording and reproducing apparatus which enables a stable recording and reproduction performance operation even in the case where a relative tilt occurs between an information recording medium and an optical pickup, without enlarging the apparatus.

The present invention describes in detail means for solving the above-mentioned problems as follows.

According to the present invention, there is provided an optical information recording and reproducing apparatus including: a first laser light source; a spatial light modulator for generating information light and reference light sharing an optical axis from a light beam of the first laser light source; an objective lens for irradiating an information recording medium with a light beam from the spatial light modulator; and a driving mechanism for moving the objective lens in a direction orthogonal to an optical axis of the objective lens in accordance with an incident angle of light passing through a center of the spatially modulated light beam with respect to the information recording medium.

Further, the present invention is characterized in that a light-receiving surface of the photodetector is divided into a plurality of portions, and the incident angle is detected based on a light-receiving amount of each light-receiving surface portion.

Thus, an incident light axis to a hologram medium is optimized by parallel movement of an objective lens, so that stable reproduction performance can be obtained with an extremely simple configuration, and apparatus compatibility can be kept satisfactorily.

According to the present invention, since an objective lens is controlled so that a center light beam of a spatial modulation pattern is always incident normally upon a recording medium, stable recording and reproduction can be performed even in a case where a disk is warped or information is recorded in a state where a disk is tilted.

Further features of the present invention will become apparent from the following description of exemplary embodiments with reference to the attached drawings.

### BRIEF DESCRIPTION OF THE DRAWINGS

FIG. 1 is a cross-sectional view showing a hologram recording medium 1 in Embodiment 1 of the present invention.

FIG. 2 is a block diagram showing an optical system of a holographic memory (collinear system) of a coaxial type in Embodiment 1 of the present invention.

FIG. 3 is a perspective view showing a two-axis actuator 31 in Embodiment 1 of the present invention.

FIG. 4 is a block diagram of a control system in Embodiment 1 of the present invention.

FIG. 5 is a plan view showing a light-receiving pattern of a quadrant sensor.

FIG. 6 is a side view showing a mode of a detection of a lens position signal.

FIGS. 7A and 7B are side views each showing a principle of a control of a light beam incident angle with respect to a hologram recording medium by lens position control.

FIG. 8 is a block diagram showing an optical system of a holographic memory (collinear system) of a coaxial type in Embodiment 2 of the present invention.

FIG. 9 is a block diagram of a control system in Embodiment 2 of the present invention.

FIG. 10 is a block diagram showing a conventional optical system of a holographic memory (collinear system) of a coaxial type.

### DESCRIPTION OF THE EMBODIMENTS

Hereinafter, a best mode for carrying out the present invention will be described with reference to the attached drawings.

### Embodiment 1

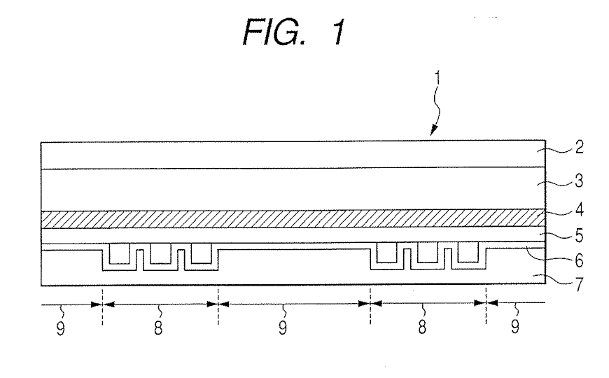

FIG. 1 is a cross-sectional view showing a hologram recording medium 1 in Embodiment 1 of the present invention.

The hologram recording medium 1 is composed of a cover layer 2 of a transparent substrate, a hologram recording layer 3, a wavelength selection reflective film 4, a gap layer 5, a reflective film 6, and a pre-format substrate 7 from the side of an objective lens.

The pre-format substrate 7 is a disk-shaped substrate formed of polycarbonate, glass, or the like.

In the pre-format substrate 7, address servo areas 8 as a plurality of positioning regions extending in a line shape in a radial direction are provided at a predetermined angle interval, and a fan-shaped section between adjacent address servo areas corresponds to data area 9.

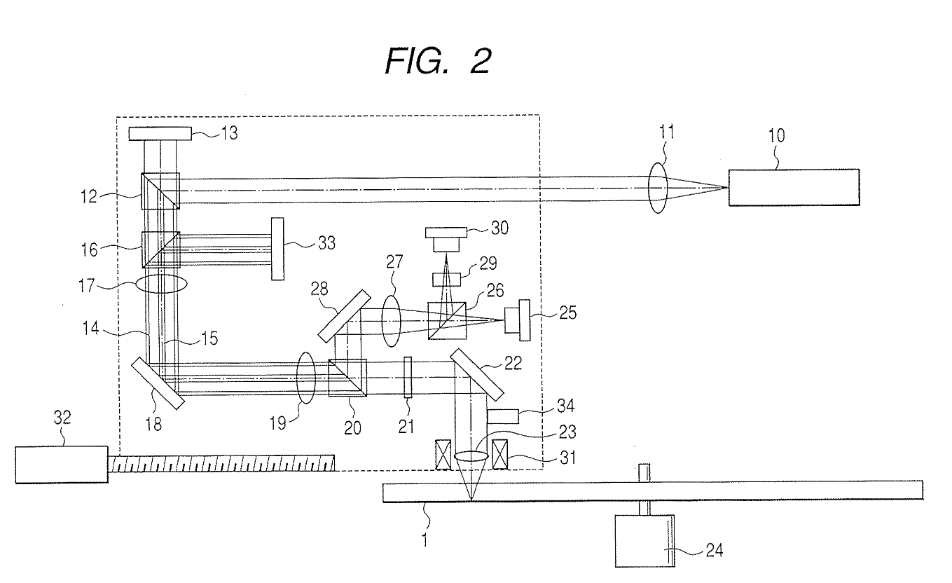

FIG. 2 is a block diagram showing an optical system of a holographic memory (collinear system) of a coaxial type in this embodiment.

First, a case where recording is performed with respect to the hologram recording medium 1 serving as a recording medium by using the above-mentioned optical system will be described.

A light beam outputted from a green laser 10 of a light source is collimated by a collimator 11, and irradiates a spatial light modulating element SLM 13 via a beam splitter 12.

In FIG. 2, a deformable mirror device (DMD) is used for the SLM 13.

Light reflected by a pixel representing information “1” on the SLM 13 is reflected to a hologram recording medium 1, and light reflected by a pixel representing information “0” is not reflected to the hologram recording medium 1.

On the collinear SLM 13, a portion modulating reference light 14 and a portion modulating information light 15 surrounding the portion modulating the reference light 14 in an annular shape are provided.

The reference light 14 and the information light 15 reflected by the pixel representing the information “1” on the SLM 13 are transmitted through a polarized beam splitter PBS 16 as P-polarized light. After that, the reference light 14 and the information light 15 are outputted toward the hologram recording medium 1 via a relay lens (1) 17, a mirror 18, a relay lens (2) 19, and a dichroic BS 20.

The reference light 14 and the information light 15 transmitted through the quarter wavelength plate QWP 21 and converted into circularly polarized light (e.g., right-handed circularly polarized light) are reflected by a mirror 22 to be incident upon an objective lens 23 at a focal distance F.

A pattern formed on the SLM 13 by the two relay lenses (1) 17 and (2) 19 forms an intermediate image at a distance F before the objective lens 23.

Thus, a so-called 4F optical system is configured, in which a pattern image (not shown) on the SLM 13, the objective lens 23, and the hologram recording medium 1 are placed at a distance F from each other.

The hologram recording medium 1 has a disk shape, and is held rotatably on a spindle motor 24.

The reference light 14 and the information light 15 are condensed onto a disk by the objective lens 23 and interfere with each other to form an interference fringe. On a polymer material in a recording medium, an interference fringe pattern during this recording is recorded as a refractive index distribution, and a digital volume hologram is formed.

A red laser 25 for emitting laser light to a recording medium which is non-photosensitive thereto is provided, in addition to a green laser 10 for performing recording and reproduction with respect to a hologram, whereby the displacement of the hologram recording medium 1 can be detected with high precision, with the above-mentioned reflective film being a reference surface.

As a result, even when surface deviating and decentering occur in the hologram recording medium 1, a recording spot can be allowed to follow the recording medium surface dynamically using an optical servo technique, and an interference fringe pattern can be recorded with high precision.

Hereinafter, the above-mentioned matter will be described briefly.

A linearly polarized light beam outputted from the red laser 25 is transmitted through a beam splitter BS 26, collimated by a lens 27, reflected by the mirror 28 and the dichroic BS 20, and outputted to the hologram recording medium 1.

The light beam transmitted through the quarter wavelength plate QWP 21 and converted into circularly polarized light (e.g., right-handed circularly polarized light) is reflected by the mirror 22 to be incident upon the objective lens 23, and is condensed as a minute light spot on a reflective surface of the hologram recording medium 1.

The reflected light beam becomes reverse circularly polarized light (e.g., left-handed circularly polarized light), and is incident upon the objective lens 23 again to be collimated. After that, the collimated light beam is reflected by the mirror 22, transmitted through the quarter wavelength plate QWP 21, and converted into a linearly polarized light beam perpendicular to a forward path.

The light beam reflected by the dichroic BS 20 is reflected by the beam splitter BS 26 via the mirror 28 and the lens 27 in the same way as in the forward path, transmitted through a cylindrical lens 29, and guided to a photodetector 30.

The photodetector 30 has four-divided light-receiving surfaces. A two-axis actuator 31 is of a small type used for a CD, a DVD, or the like, and holds only the objective lens 23. Reference numeral 32 denotes a carriage, 33 denotes a CMOS sensor, and 34 denotes a photosensor.

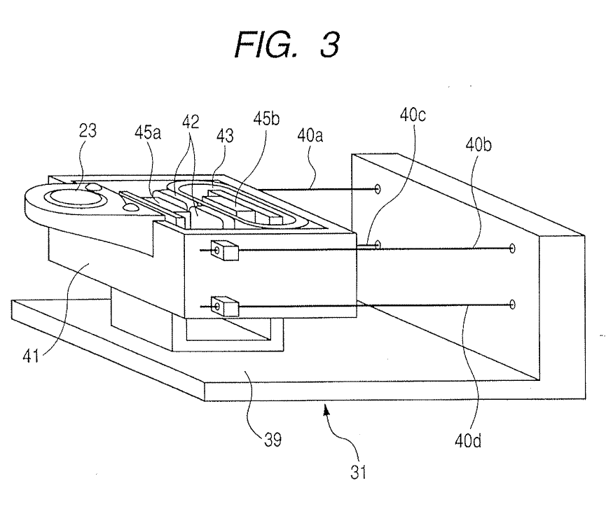

FIG. 3 is a perspective view showing the two-axis actuator 31 in Embodiment 1 of the present invention.

The two-axis actuator 31 is composed of a base 39, suspension wires 40a to 40d fixed to the base 39, a lens holder 41 supported by the suspension wires 40a to 40d, a tracking coil 42 and a focus coil 43 attached to the lens holder 41, a yoke 41 fixed to the base 39, and two opposed magnets 45a and 45b attached to the yoke 41. The objective lens is attached to the lens holder 41.

The focus coil 43 is energized, whereby the objective lens 23 moves in an optical axis direction, and the tracking coil 42 is energized, whereby the objective lens 23 moves in a direction orthogonal to the optical axis.

The optical system other than the green laser 10 and the collimator 11 is fixed onto the carriage 32, and is movable in a radial direction of the hologram recording medium 1. An access to a desired track is performed by driving the carriage 32.

Next, a case where information is reproduced from the hologram recording medium 1 using the above-mentioned optical system will be described.

A light beam outputted from the green laser 10 of a light source irradiates the spatial light modulating element SLM 13 in the same way as in recoding. During reproduction, only a portion modulating the reference light 14 on the SLM 13 represents the information “1”, and a portion modulating the information light 15 displays information “0”.

Thus, only a part of the reference light 14 reflected by a pixel is reflected to the hologram recording medium 1, and the information light 15 is not reflected to the hologram recording medium 1.

In the same way as in recording, the reference light 14 becomes circularly polarized light (e.g., right-handed circularly polarized light) to be condensed onto a disk, and reproduces information light from the recorded inference fringe. The information light reflected by the reflective film in the recording medium becomes reverse circularly polarized light (e.g., left-handed circularly polarized light), and is incident upon the objective lens 23 again to be collimated. After that, the collimated light is reflected by the mirror 22, transmitted through the quarter wavelength plate QWP 21, and converted into a linearly polarized light beam (S-polarized light) perpendicular to the forward path.

At this time, an intermediate image of a display pattern of the SLM 13 reproduced at a distance F from the objective lens 23 is formed.

The light beam transmitted through the dichroic BS 20 travels to the polarized beam splitter PBS 16 via the relay lens (2) 19, the mirror 18, and the relay lens (1) 17. The light beam reflected by the PBS 16 forms an image of a display pattern of the SLM 13 on the CMOS sensor 33 at a position conjugate to the spatial light modulating element SLM 13 by the relay lenses (2) and (1).

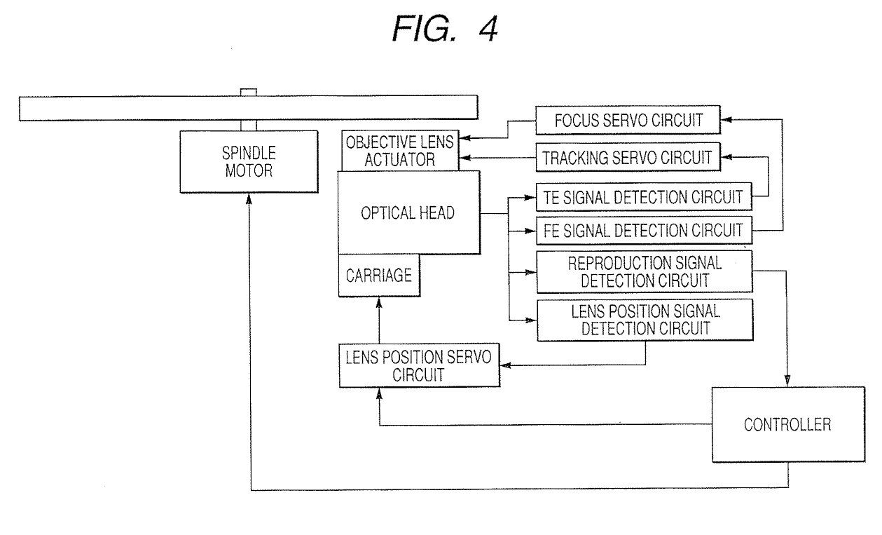

FIG. 4 is a block diagram of a control system in Embodiment 1 of the present invention.

An output from an optical head is transmitted to each signal detection circuit, and a reproduced signal, a focus error signal, a tracking error signal, and a lens position signal are detected.

Based on the focus error signal and the tracking error signal, the objective lens actuator 31 is driven by each servo circuit.

The lens position signal is transmitted to a lens position servo circuit to become a control signal for carriage driving. The controller rotates a spindle motor, and controls a lens position (described later) based on the reproduced signal.

The focus and tracking servo control operations are common for both recording and reproduction.

A focus error signal is detected based on the output of the quadrant sensor in an address servo area.

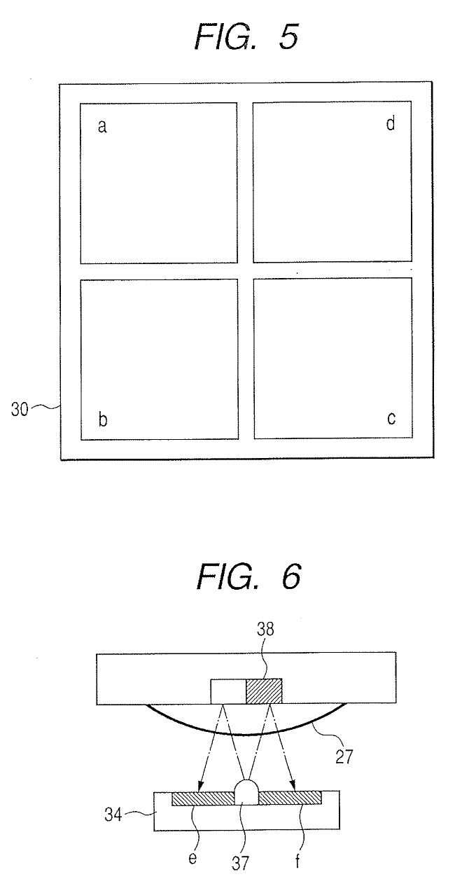

FIG. 5 is a plan view showing a light-receiving pattern of the quadrant sensor. When outputs from light-receiving surfaces a to d are represented by A to D, respectively, a focus error signal FE is obtained by the following expression.
FE=(A+C)−(B+D)

The focus control is performed by driving the two-axis actuator 31 with the objective lens 23 mounted thereon in a direction perpendicular to a disk surface, based on a focus error signal.

A tracking error signal is detected based on the outputs of the quadrant sensor in an address servo area. A tracking error signal TE is obtained by the following expression.
TE=(A+D)−(B+C)

Tracking control is performed by driving the two-axis actuator 31 with the objective lens 23 mounted thereon in a direction horizontal to the disk surface, based on the tracking error signal.

Herein, the procedure of lens position control will be described. The lens position control is performed by the carriage 32 with a lens position signal LPrad described below being a target value.

Thus, the carriage 32 performs an operation of allowing the optical system to follow track decentering, with the objective lens position fixed. A minute high-frequency component that cannot be followed by the drive of the carriage 32 is followed by the tracking operation of the objective lens 23.

FIG. 6 is a side view showing a mode of a detection of a lens position signal.

First, the lens position control during recording will be described. A lens position signal is detected by a photosensor 34 composed of an LED 37, a monochromic pattern 38, and a division photodiode as shown in FIG. 6. Note that reference numeral 27 denotes a lens.

The monochromic pattern 38 is irradiated with light outputted from the LED 37, and reflected light is received by the division photodiode. When outputs from the light-receiving surfaces e and f of the division photodiode are represented by E and F, respectively, a lens position signal LPrad in a radial direction is given as follows.
LPrad=E−F

The lens position is controlled with lens position signal LPrad of zero being a target value.

Subsequently, the lens position control during reproduction will be described. On the hologram recording medium 1, patterns for detecting a tilt are recorded at a plurality of predetermined portions.

During reproduction, the patterns for detecting a tilt are reproduced, a level distribution (histogram) is calculated for each recording pixel from the output of the CMOS sensor 33, and the standard deviation thereof is calculated.

Reproduction is performed while a constant offset being given to the target value of the objective lens position control, and the peak position of the standard deviation is detected. The subsequent reproduction is controlled with the objective lens position at which the calculated standard deviation becomes a peak being a target value.

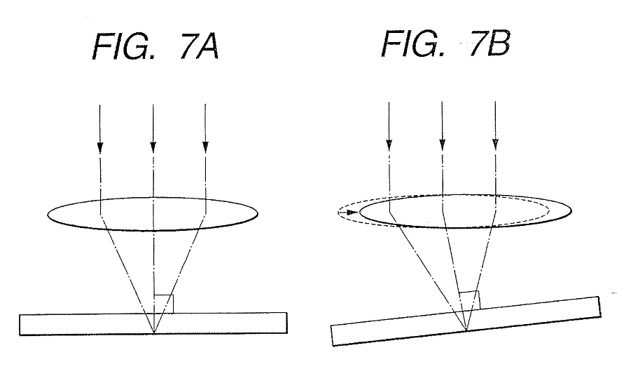

FIGS. 7A and 7B are side views showing the principle of the control of a light beam incident angle with respect to the hologram recording medium by the lens position control.

In a case where there is no decentering between the spatially modulated light beam and the objective lens position, a center light beam is normally incident upon the hologram recording medium with the tilt of the center light beam unchanged, as shown in FIG. 7A. On the other hand, when the objective lens position is decentered with respect to the spatially modulated light beam, the light beam incident upon the hologram recording medium is tilted by the decentered amount, as shown in FIG. 7B.

Thus, by controlling the parallel shift amount of the objective lens, the light beam incident angle with respect to the hologram recording medium can be controlled.

Consequently, in a case where the hologram recording medium is tilted, or information recorded with a tilted light beam is reproduced, the tilt of the incident light beam can be aligned with the above-mentioned tilt.

In this embodiment, although the objective lens position control in the tangent direction of a track is not performed, a driving mechanism may be provided so that the objective lens position control in the tangent direction can be performed in the same way as that in the radial direction. Further, the lens position control may be performed during reproduction in the same way as that during recording.

As described above, even in the hologram recording medium with information recorded while being tilted, stable reproduction performance can be obtained with an extremely simple configuration.

### Embodiment 2

The configuration of a hologram recording medium in this embodiment is similar to that in Embodiment 1. The optical system in this embodiment is also substantially similar to that in Embodiment 1 except for an optical system for servo.

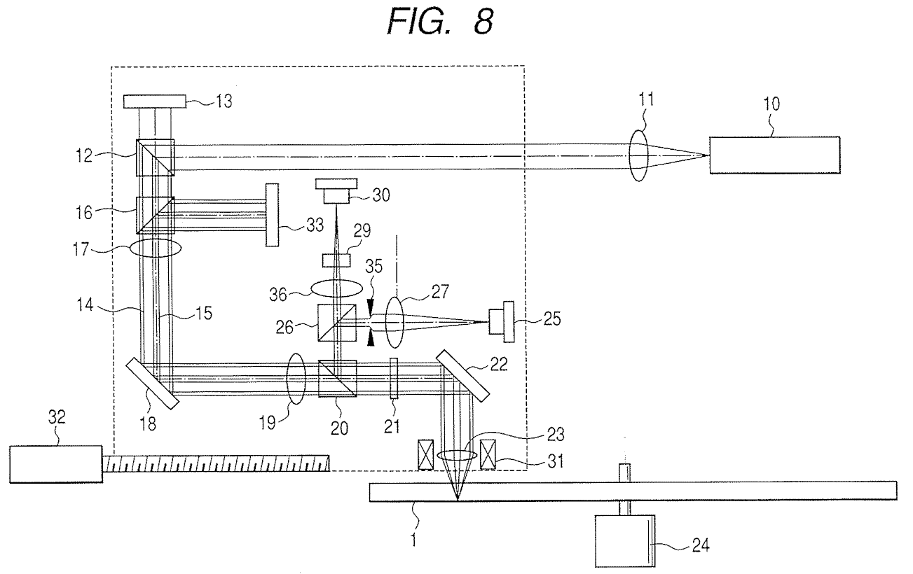

FIG. 8 is a block diagram showing an optical system of a holographic memory (collinear system) of a coaxial type in Embodiment 2 of the present invention.

A linearly polarized light beam outputted from a red laser 25 is collimated by a lens 27, transmitted through an opening 35, reflected by a beam splitter BS 26, reflected by a dichroic BS 20, and outputted toward a hologram recording medium 1.

The light beam transmitted through a quarter wavelength plate QWP 21 and converted into circularly polarized light (e.g., right-handed circularly polarized light) is reflected by a mirror 22 to be incident upon an objective lens 23. After that, the light beam is condensed as a minute optical spot on a reflective surface of the hologram recording medium 1.

The reflected light beam becomes reverse circularly polarized light (e.g., left-handed circularly polarized light), and is incident upon the objective lens 23 again to be collimated. After that, the collimated light beam is reflected by the mirror 22, transmitted through the quarter wavelength plate QWP 21, and converted into a linearly polarized light beam perpendicular to a forward path.

The light beam reflected by the dichroic BS 20 passes through the beam splitter BS 26, passes through a cylindrical lens 29 via a lens 36, and is guided to a photodetector 30. The photodetector 30 has a four-divided light-receiving surface. A two-axis actuator 31 is of a small type used for a CD, a DVD, or the like, and holds only the objective lens 23.

The opening 35 is formed to be smaller by hundreds of microns compared with an effective diameter of the objective lens 23. In this embodiment, the effective system of the objective lens 23 has a diameter of 3.5 mm, and the diameter of the opening is 3 mm. Further, the center of the opening and the center axis of a modulation pattern of the SLM 13 are adjusted to be fixed with good precision.

The optical system other than the green laser 10 and the collimator 11 is fixed onto the carriage 32, and is movable in a radial direction of the disk. An access to a desired track is performed by driving the carriage 32. It should be noted that the same reference numerals as those in FIG. 2 denote the same components as those therein.

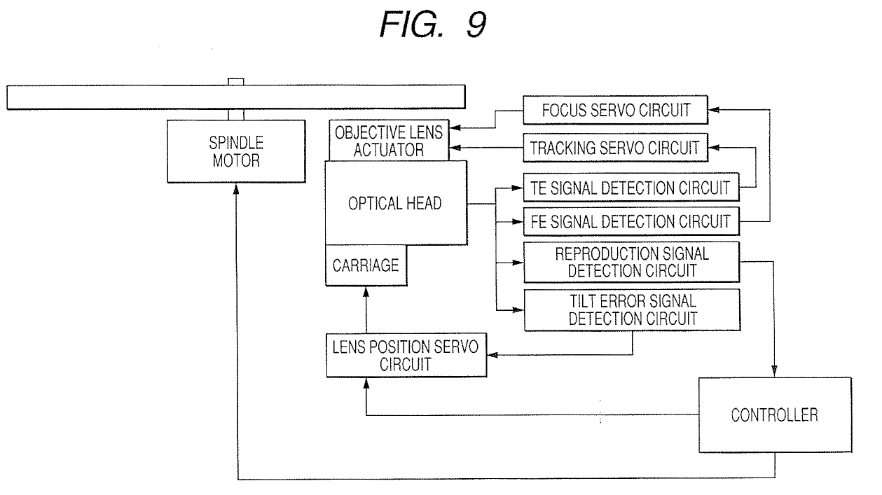

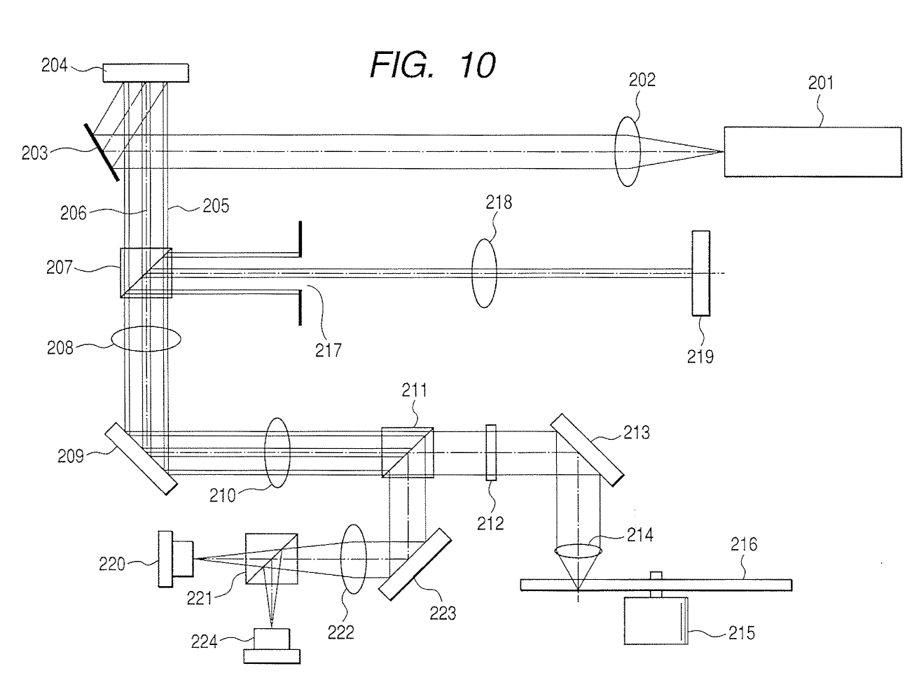

FIG. 9 is a block diagram of a control system in Embodiment 2 of the present invention.

An output from an optical head is transmitted to each signal detection circuit, and a reproduced signal, a focus error signal, a tracking error signal, and a tilt error signal are detected.

Based on the focus error signal and the tracking error signal, the objective lens actuator is driven by each servo circuit. A tilt error signal is transmitted to a lens position servo circuit to become a control signal for driving a carriage. A controller controls a rotation of a spindle motor.

The focus and tracking servo control operations are common for both recording and reproduction.

A focus error signal is detected based on the output of the quadrant sensor in an address servo area. FIG. 5 shows a light-receiving pattern of the quadrant sensor. When outputs from light-receiving surfaces a to d are represented by A to D, respectively, a focus error signal FE is obtained by the following expression.
FE=(A+C)−(B+D)

The focus control is performed by driving the two-axis actuator 31 with the objective lens 23 mounted thereon in a direction perpendicular to a disk surface, based on a focus error signal.

A tracking error signal is detected based on the outputs of the quadrant sensor in an address servo area. A tracking error signal TE is obtained by the following expression.
TE=(A+D)−(B+C)

Tracking control is performed by driving the two-axis actuator 31 with the objective lens 23 mounted thereon in a direction horizontal to the disk surface, based on the tracking error signal.

Herein, the procedure of lens position control will be described.

In this embodiment, the lens position control is common for recording and reproduction.

The lens position control is performed by the carriage 32 based on a tilt error signal TILTrad shown below.

Thus, the carriage 32 performs an operation of allowing the optical system to follow track decentering, with the objective lens position fixed. A minute high-frequency component that cannot be followed by the drive of the carriage 32 is followed by the tracking operation of the objective lens 23.

A tilt error signal is detected based on the output of the quadrant sensor in an area without prepits in an address servo area. The tilt error signal TILTrad in a radial direction is obtained by the following expression.
TILTrad=(A+D)−(B+C)

During recording or reproduction, feedback control is performed with a target value being set to zero with respect to the carriage 32, based on the tilt error signal TILTrad.

Next, the principle of detecting a tilt error signal will be described.

In the case where an optical axis center is normally incident upon a disk, the optical axis of reflected light is matched with the optical axis of incident light. However, in the case where the optical axis center is diagonally incident upon the disk, the optical axis of reflected light is not matched with the incident light, and a light beam is shifted in a tilt direction.

The shift amount is detected on the divided light-receiving surface, whereby detection is performed. At this time, the incident light beam to the objective lens is limited to be smaller than the effective diameter of the objective lens, so that the incident angle of the optical axis center to the disk surface is detected with good precision without being influenced by a change in intensity distribution due to the objective lens shift.

During reproduction, the lens position control using a pattern for detecting a tilt may be performed in the same way as in Embodiment 1. Further, in this embodiment, although the objective lens position control in the tangent direction of a track is not performed, a driving mechanism may be provided so that the objective lens position control in the tangent direction can be performed in the same way as that in the radial direction.

In this embodiment, the incident angle of a light beam passing through the center of an SLM pattern with respect to the hologram recording medium is detected, and controlled by the parallel movement of the objective lens. Therefore, stable recording and reproduction can be performed even in the case where a disk is warped.

Further, since the relative tilt between drives can be absorbed, apparatus compatibility can be maintained satisfactorily.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-343879, filed Nov. 29, 2005 which is hereby incorporated by reference herein in its entirety.

What is claimed is:

1. An optical information recording and reproducing apparatus, comprising:
a first laser light source;
a spatial light modulator for generating information light and reference light sharing an optical axis from a light beam of the first laser light source;
an objective lens for irradiating an information recording medium with a light beam from the spatial light modulator; and
a driving mechanism for moving the objective lens in a direction orthogonal to an optical axis of the objective lens in accordance with an incident angle of light passing through a center of the spatially modulated light beam with respect to the information recording medium.

2. The optical information recording and reproducing apparatus according to claim 1, further comprising:
a second laser light source for emitting laser light to the information recording medium which is non-photosensitive thereto; and
a photodetector for detecting a light beam irradiated from the second laser light source and reflected by the information recording medium,
wherein the incident angle is detected by the photodetector.

3. The optical information recording and reproducing apparatus according to claim 2, wherein the driving mechanism integrally drives the spatial light modulator, the objective lens, the second laser light source, and the photodetector in accordance with the incident angle.
